(19) United States
(12) Patent Application Publication
(10) Pub. No.: US 2022/0288875 A1
(43) Pub. Date: Sep. 15, 2022

(54) MOULDING PROCEDURES

(71) Applicant: Alan Harper Composites Limited, Saltash (GB)

(72) Inventor: Alan Roger Harper, Cornwall (GB)

(21) Appl. No.: 17/672,989

(22) Filed: Feb. 16, 2022

(30) Foreign Application Priority Data
Feb. 16, 2021 (GB) 2102132.4

(51) Int. Cl. B29C 70/48

(52) U.S. Cl. CPC B29C 70/48; B29K 2101/10

(57) ABSTRACT

A method of moulding includes positioning a fibre between a hard mould face and flexible contra mould face, sealing the space between the two mould faces, deforming the flexible contra mould face to produce a channel, introducing a thermosetting resin into the space between the two mould faces, and returning the flexible contra mould face to its undeformed condition before the onset of resin gel.

### FIELD OF THE INVENTION

This invention relates to moulding procedures and is concerned with resin flow paths within composite closed moulds.

When glass fibre or another form of fibre is impregnated with a thermosetting resin in a closed mould environment, there is always a concern to fill the mould within a sufficient time, i.e. before the resin gels.

In the field of composite production, there are many different methods of infusing fibres compacted between two matching mould faces. The current state of the art involves the use of vacuum assistance within the fibres during resin infusion and curing. Matched moulds can be two machined hard faces or, alternatively, one hard face and a matched flexible contra face,

Traditionally, resin has been encouraged to flow more quickly by the use of consumable flow mesh and/or disposable flow channels under a sealed vacuum membrane sandwiched between the mesh and the fibre pack. This is especially the case when moulding with high density woven or multiracial fibre, the permeability of which is notoriously low.

As these flow aids do not form part of the final product, they must be removed after curing and there is thus a need for an additional release film, commonly known as peel ply. All these additional process aids are consumable and become waste. There is an additional waste of resin which has contaminated these consumables.

In a desire to avoid the use of consumables, reusable systems have been developed. Various methods gave been introduced to provide priority resin flow paths through built-in channels and/or secondary vacuum channel forming methods.

It is an object of the present invention to provide an improved method of moulding.

### SUMMARY OF THE INVENTION

According to the present invention there is provided a method of moulding which includes:

positioning a fibre between a hard mould face and flexible contra mould face,

sealing the space between the two mould faces,

deforming the flexible contra mould face to produce a channel,

introducing a thermosetting resin into the space between the two mould faces, and

returning the flexible contra mould face to its undeformed condition before the onset of resin gel.

### BRIEF DESCRIPTION OF THE DRAWINGS

FIG. 1 is a sectional view of a first embodiment of mould before the commencement of the moulding procedure,

FIG. 2 is a sectional view of the mould of FIG. 1 at a specific stage of the moulding procedure,

FIG. 3 is a sectional view of a second embodiment of mould before the commencement of the moulding procedure, and

FIG. 4 is a sectional view of the mould of FIG. 3 at the same specific stage of the moulding procedure.

### DESCRIPTION OF THE PREFERRED EMBODIMENTS

FIG. 1 shows a rigid mould face 1, a matching flexible mould face 2 and a cavity 3 between the two mould faces 1 and 2. A fibre pack 4 is positioned within the cavity 3, which is then placed under vacuum. Unpressurised sealed ducts 5 exist within the flexible mould face 2 and these are in the form of two parallel passages between which there is a gap 6. The flexible mould face 2 is made from a flexible elastomer, such as a silicone polymer.

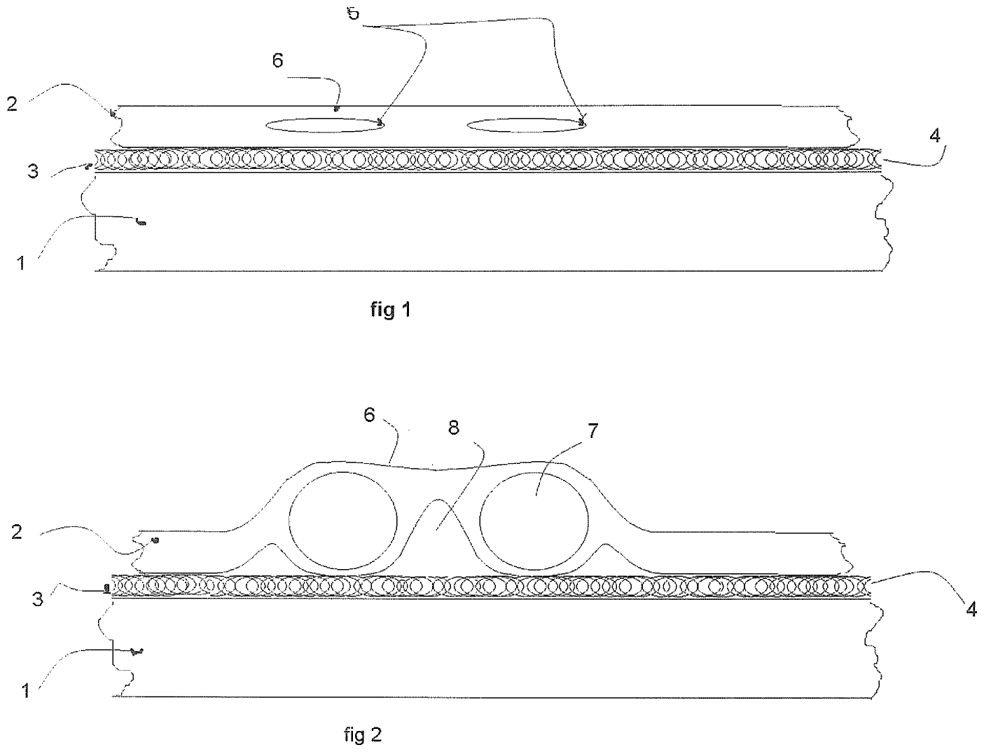

FIG. 2 shows the same mould structure after a gas or liquid has been introduced under pressure into the ducts 5 to deform the flexible mould face 2 into an inflated shape 7. The resulting distortion of the gap 6 results in the formation of a channel 8 above the fibre pack 4. The pressure used to produce the inflated shape is typically up to 4 bar and will depend on the Shore hardness of the elastomer and its thickness.

A thermosetting resin is then introduced into the cavity 3 via the channel 8 and the infusing resin is channelled more easily over the fibre pack 4 as the permeability of the fibre pack 4 within the channel 8, i.e. as shown in FIG. 2, is far greater than it was in the compacted condition shown in FIG. 1.

After the resin impregnation of the fibre-filled cavity 3 has been completed, but before the onset of resin gel, the channel 8 is returned to its original undistorted condition by removal of the pressure within the ducts 5.

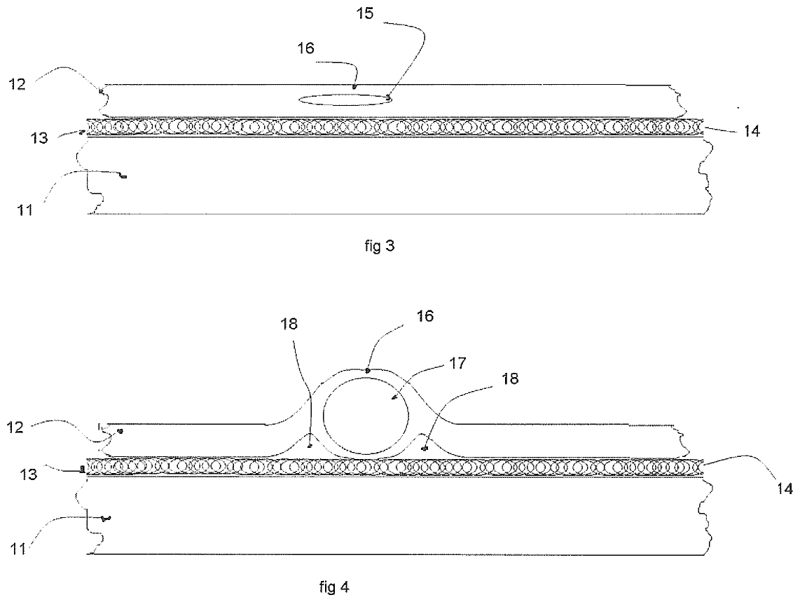

FIGS. 3 and 4 show a second embodiment of the invention. FIG. 3 illustrates a closed mould section with a lower hard mould face 11, a cavity 13 which is under vacuum pressure and contains a layer of a dry fibre 14 which is tightly compacted within the cavity 13, and a sealed flexible mould face membrane 12. Within the membrane 12 there is a lay flat pipe-style cavity 15 embedded at zone 16 of the membrane 12. The pipe-style cavity 15 is at neutral atmospheric pressure and remains flat even though the cavity 13 is under vacuum.

FIG. 4 shows the same mould cross-section as FIG. 3, but in this configuration the pipe-style cavity has been pressurised, typically to a pressure within the range of 1 to 4 bar, so that it is inflated and is in the form of a substantially circular cross-section passage 17. The passage 17 is within the membrane 12 and its production by pressure inflation distorts zone 16 of the membrane 12 and creates two voids 18, one on each side of the inflated passage 17. These voids 18 serve as open flow channels during resin infusion and permit relatively free movement of the resin into the fibre 14. On completion of the resin infusion procedure, the passage 17 is vented to atmosphere and zone 16 reverts to its original flat shape as shown in FIG. 3.

Inflation of the cavity 15 and deflation of the passage 17 means that the voids 18 permit infusion of the resin but are then removed before the resin gels.

What is claimed is:

1. A method of moulding which includes:
positioning a fibre between a hard mould face and flexible contra mould face,
sealing the space between the two mould faces,
deforming the flexible contra mould face to produce a channel,
introducing a thermosetting resin into the space between the two mould faces, and
returning the flexible contra mould face to its undeformed condition before the onset of resin gel.

2. The method of moulding as claimed in claim 1, in which deformation of the flexible contra mould face is effected by introducing a fluid under pressure into at least one duct in the flexible contra mould face.

3. The method of moulding as claimed in claim 1, in which deformation of the flexible contra mould face is effected by introducing a fluid under pressure into two parallel ducts in the flexible contra mould face.
